(19) United States
(12) Patent Application Publication
(10) Pub. No.: US 2005/0199775 A1
(43) Pub. Date: Sep. 15, 2005

(54) Vibration isolation support system for vehicle engine and transmission

(76) Inventors: David Kaminski, Lake Orion, MI (US); Philip Zane, Macomb, MI (US)

Correspondence Address: DAIMLERCHRYSLER INTELLECTUAL CAPITAL CORPORATION;CIMS 483-02-19, 800 CHRYSLER DR EAST, AUBURN HILLS, MI, 48326-2757, US

(21) Appl. No.: 10/796,678

(22) Filed: Mar. 9, 2004

(51) Int. Cl. F16M 5/00; B60K 1/00

(52) U.S. Cl. 248/638; 180/291

(57) ABSTRACT

A vibration isolation support for mounting an engine in a vehicle frame, the engine having a theoretical roll axis, the vibration isolation support including an engine bracket fixed to the engine; a frame bracket fixed to the vehicle frame; and an isolator connected between the engine bracket and the frame bracket, where the isolator is radially symmetrical about a longitudinal axis, and the engine bracket is fixed to the engine and the frame bracket is fixed to the frame such that a vertical plane drawn through the isolator's longitudinal axis is perpendicular to a horizontal plane drawn through the theoretical roll axis, and the isolator's longitudinal axis intersects the horizontal plane through the theoretical roll axis at an acute angle that is less than or equal to 45°.

### FIELD OF THE INVENTION

This invention relates to a vibration isolation support system for an internal combustion engine. More specifically, the present invention is directed to a vibration isolation support system for mounting and supporting an internal combustion engine and/or transmission.

### BACKGROUND OF THE INVENTION

It is well known that a reduction in overall vehicle noise can be achieved by isolating the vibrations emanating from the vehicle engine and transmission. Generally this is accomplished by using a vibration absorbing material as a component of the engine and transmission mounting structure.

Such a vibration absorbing structure is illustrated in U.S. Pat. No. 4,930,743 which describes a mounting structure having a first bracket connected to the engine and a second bracket connected to the frame where the first bracket and the second bracket are vertically aligned. Engine vibration is isolated by connecting the first bracket to the second bracket with vibration absorbing elastic material. Similarly, U.S. Pat. No. 5,437,344 illustrates the use of a mount rubber to isolate engine vibration.

Another approach is the active system described in U.S. Pat. No. 5,310,017. This patent describes continuously active pressure accumulators configured to provide constant fluid and gas pressure to vibration isolation mounts, thereby providing damping proportional to the vibration level.

The above described patents illustrate the tradeoffs that exist in current vibration isolation systems. At one end of the spectrum are simple systems that use elastomeric blocks sandwiched vertically between brackets attached to the engine and the frame that attenuate only a portion of engine vibrations. At the other end of the spectrum are the complex active systems capable of significantly damping a large portion of engine vibrations. Between the two are passive systems that use complex mounting brackets (such as shown in U.S. Pat. Nos. 4,930,742 and 5,437,344) that appear to yield improved damping when the brackets are specifically tailored to each engine configuration.

### SUMMARY OF THE INVENTION

One object of the present invention is a vibration damping support system that provides acceptable vibration isolation, is adaptable for use with a variety of engines and platforms, and is simple and inexpensive.

These and other objects of the invention are satisfied by a vibration isolation support for mounting an engine in a vehicle frame having a longitudinal axis, the engine having a theoretical roll axis, the vibration isolation support including an engine bracket fixed to the engine; a frame bracket fixed to the vehicle frame; and an isolator connected between the engine bracket and the frame bracket, where the isolator is radially symmetrical about a longitudinal axis, and the engine bracket is fixed to the engine and the frame bracket is fixed to the frame such that a vertical plane drawn through the isolator's longitudinal axis is perpendicular to a horizontal plane drawn through the theoretical roll axis, and the isolator's longitudinal axis intersects the horizontal plane through the theoretical roll axis at an acute angle that is less than or equal to 45°.

### BRIEF DESCRIPTION OF THE DRAWINGS

FIG. 1 is a perspective view of a vibration isolation support according to the present invention.

FIG. 2 is a longitudinal cross section of a vibration isolation support according to the present invention.

FIG. 3 shows a rear cross section of a vibration isolation support according to the present invention.

FIG. 4 is a perspective view showing the relationship between a horizontal plane drawn through the theoretical roll axis of the engine (and/or the transmission) for an east-west mounted engine and a line and a vertical plane drawn through the isolator's longitudinal axis.

FIG. 5 is a perspective view showing the relationship between a horizontal plane drawn through the theoretical roll axis of the engine (and/or the transmission) for a north-south mounted engine and a line and a vertical plane drawn through the isolator's longitudinal axis.

FIG. 6 is a top cross sectional view showing the relationship between a horizontal plane drawn through the theoretical roll axis of the engine (and/or the transmission) and a vertical plane drawn through the isolator's longitudinal axis.

FIG. 7 is a longitudinal side view showing the relationship between a horizontal plane drawn through the theoretical roll axis of the engine (and/or the transmission) and a line through the isolator's longitudinal axis.

FIG. 8 is a longitudinal cross section of a vibration isolation support according to the present invention where the isolator comprises elastomeric material surrounding a metal block.

FIG. 9 is a longitudinal cross section of a vibration isolation support according to the present invention where the isolator comprises a metal support surrounding elastomeric material.

### DETAILED DESCRIPTION

The unique vibration isolation support of the present invention avoids the problems of the prior art because it has a straightforward, inexpensive design that provides excellent vibration damping for almost any engine and/or transmission configuration such as a north-south or east-west mounted engine and/or transmission providing power for a rear wheel drive, front wheel drive, four wheel drive, or all wheel drive vehicle.

In the Figures like number refer to like parts throughout.

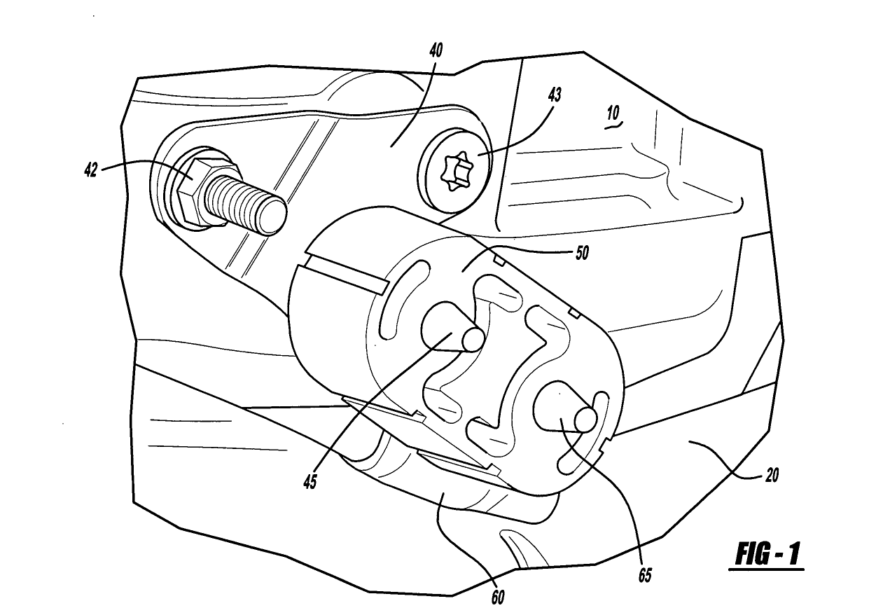

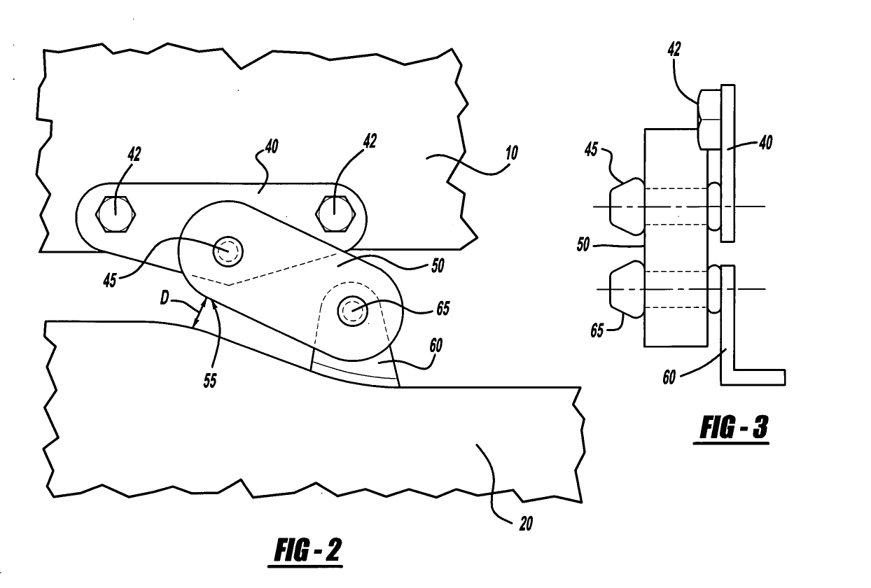

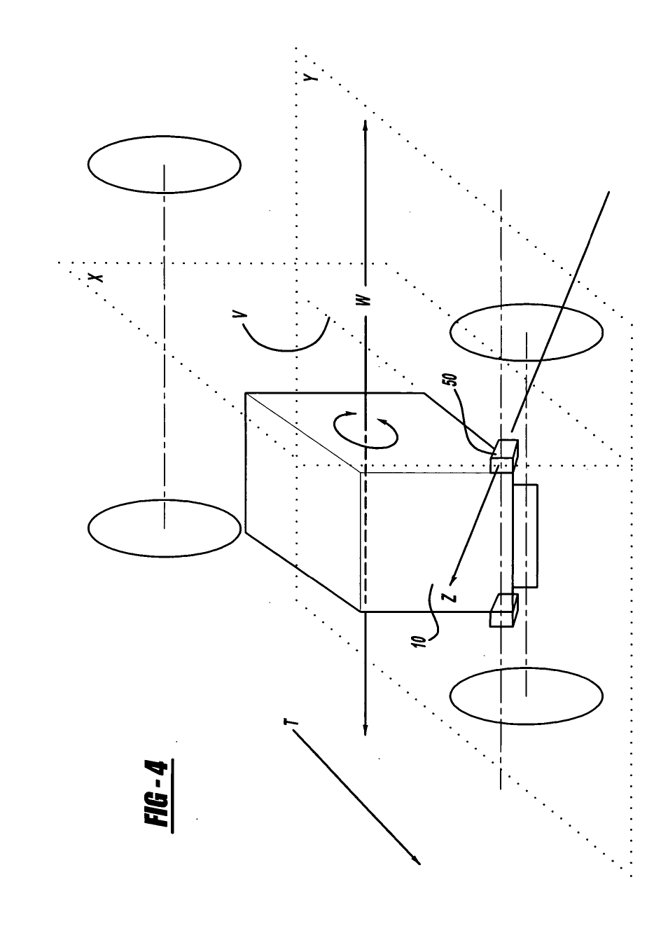

FIGS. 1 and 2 show a close-up of an engine block 10 (including the transmission case depending on the application) and the frame 20. FIG. 3 illustrates a rear cross section of the vibration isolation support. An engine bracket 40 is mounted on the engine block 10 using nuts/bolts 42, screws 43, rivets (not shown) or other appropriate fasteners. A frame bracket 60 is similarly attached to the frame 20. The engine bracket 40 has a boss 45 and the frame bracket 60 has a boss 65. A isolator 50 is mounted over the bosses 45 and 65 to provide a vibration damping connection between the engine 10 (and/or transmission) and the frame 20.

In the present invention the isolator 50 is radially symmetrical, i.e. the isolator 50 is shaped such that it has a longitudinal axis Z where any plane drawn through Z will divide the isolator 50 into two mirror images. (It is noted that due to packaging and/or desired restrictions of movement, one mirror image may be larger or smaller than to other to give different rates of movement or frequency and/or vibration absorption, and that such variations are specifically included in the present invention.)

Every engine has a theoretical roll axis. This theoretical roll axis is roughly parallel to the camshaft center about which every engine tends to roll when engine RPM's change. In east-west mounted engines where the camshaft center is perpendicular to the vehicle's direction of travel, the theoretical roll axis will be perpendicular to the vehicle's direction of travel. (In north-south mounted engines where the camshaft center is parallel to the vehicle's direction of travel, the theoretical roll axis will be parallel to the vehicle's direction of travel.)

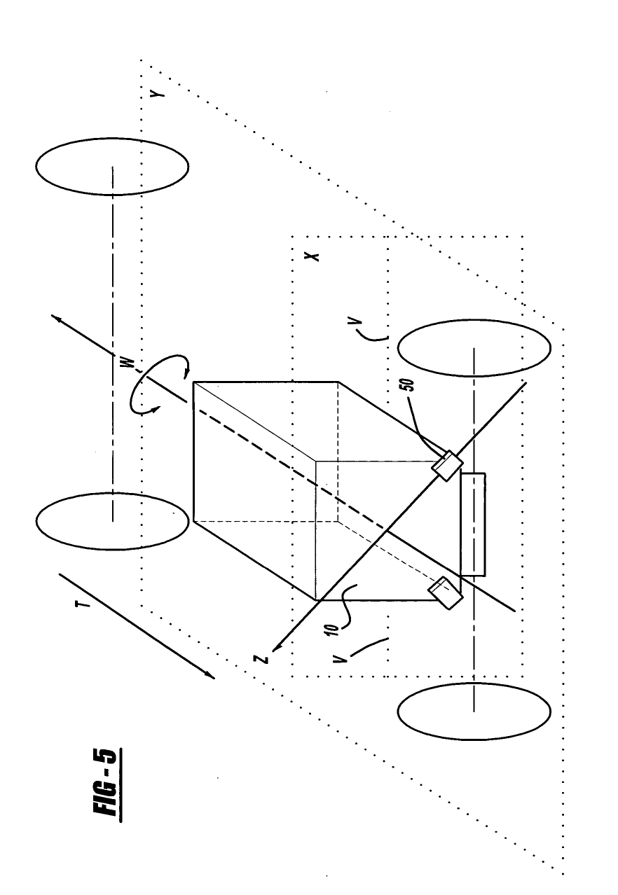

FIG. 4 illustrates the positioning of isolators 50 relative to the positioning of an east-west engine and/or transmission having a theoretical roll axis W that is perpendicular to the direction of travel T of the vehicle. Front wheel drive vehicles typically have an engine/transaxle oriented east-west. In the east-west engine illustrated in FIG. 4, all the isolators 50 (only two of which are illustrated) are mounted so that a vertical plane X drawn through the isolator's longitudinal axis is parallel to the direction of travel T and perpendicular to a horizontal plane Y drawn through the theoretical roll axis W. Further, the isolator's longitudinal axis Z intersects the horizontal plane Y at an acute angle that is less than or equal to 45°.

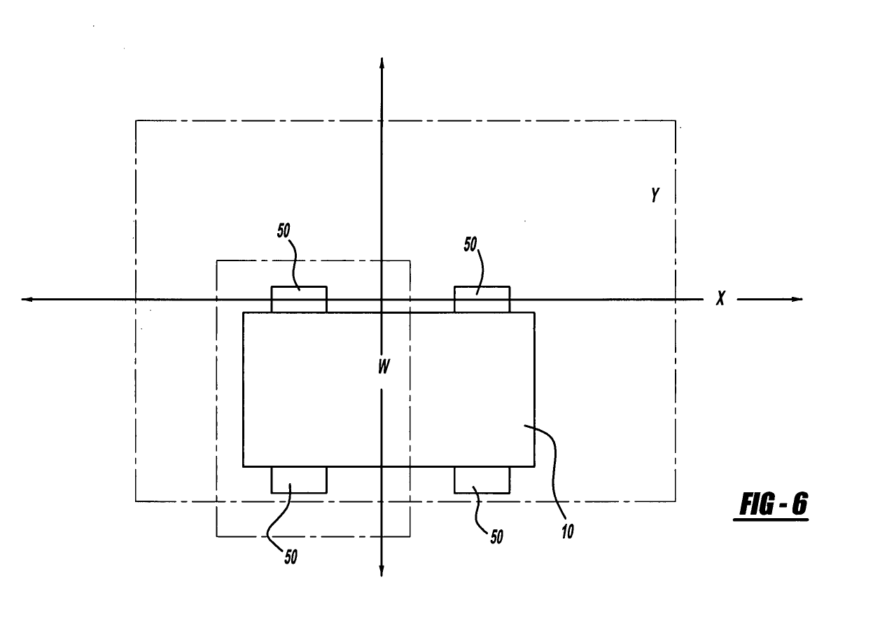

FIG. 5 illustrates the positioning of isolators 50 relative to the positioning of a north-south engine and transmission having a theoretical roll axis W that is parallel to the direction of travel T of the vehicle. Vehicles having rear wheel drive and four wheel drive typically have a north-south engine orientation. In the north-south engine illustrated in FIG. 5, all the isolators 50 (only two of which are illustrated) are mounted so that a vertical plane X drawn through the isolator's longitudinal axis is perpendicular to the direction of travel T and perpendicular to a horizontal plane Y drawn through the theoretical roll axis W. Further, the isolator's longitudinal axis Z intersects the horizontal plane Y at an acute angle that is less than or equal to 45°.

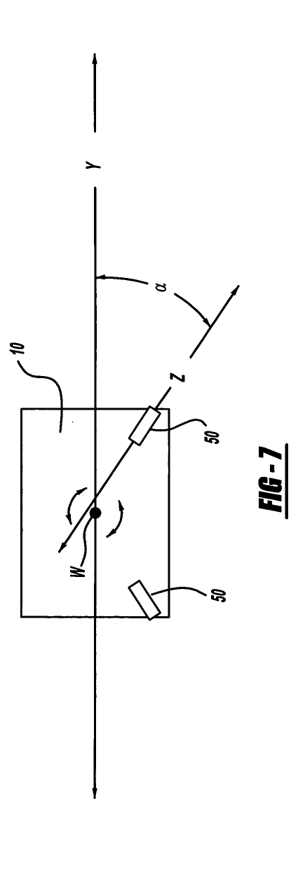

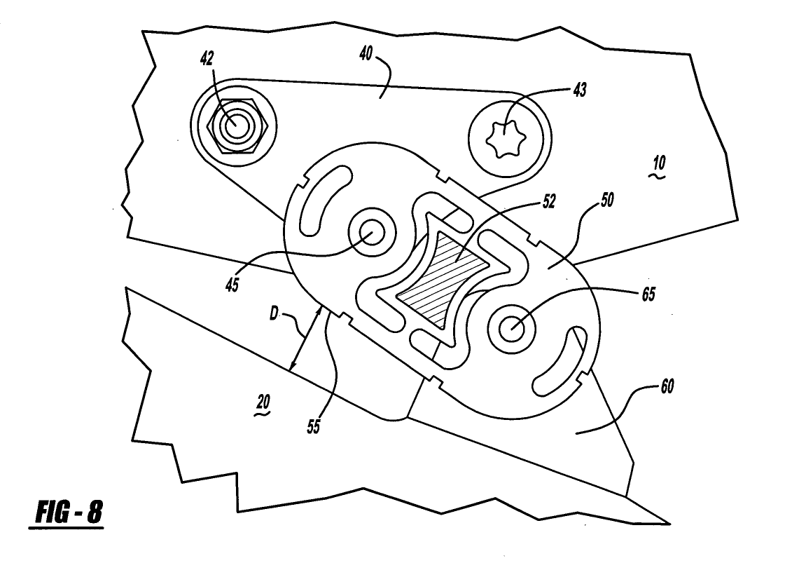

Thus, for the present invention, regardless of whether the engine is mounted east-west or north-south the engine bracket 40 and the frame bracket 60 are mounted on the engine and frame, respectively, to position the isolator 50 so that a vertical plane X drawn through the isolator's longitudinal axis is perpendicular to a horizontal plane Y drawn through the theoretical roll axis W; and the isolator's longitudinal axis Z intersects the horizontal plane through the theoretical roll axis Y at an acute angle that is less than or equal to 45°. (The perpendicular intersection of the planes X and Y is illustrated in the top view of FIG. 6, and the acute angle of intersection between the axis Z and the plane Y is illustrated in the side view of FIG. 7.)

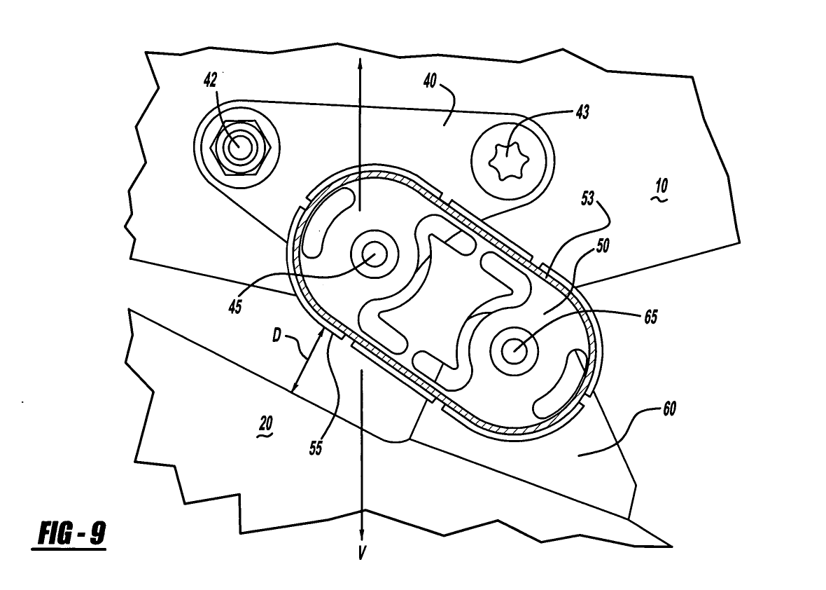

FIGS. 8 and 9 illustrate tuning the flex, bend, rebound, frequency of damped vibrations, etc. of the present invention by using a resilient member 50 formed around a metal block 52 (see, FIG. 8) or a metal band 53 (see, FIG. 9) positioned around the resilient member 50. Alternatively, the included block or band may be formed from any material that in combination with the material used to form the isolator achieves the desired overall characteristics. For example, in addition to metal, the block 52 or band 53 may be formed from an elastomeric material (different from the material of the isolator 50) or a relatively stiff material, such as plastic, reinforced plastic (fiber filled plastic), or a composite material (carbon fiber). It is also within the scope of the invention for the resilient member 50 to have present in the same isolator both a block 52 and a band 53. In such an application, both the block 52 and the band 53 may be fabricated from the same material or different materials.

A further aspect of the present invention illustrated in FIGS. 2, 7, 8, and 9 is the way in which the configuration of the present invention permits the frame of the vehicle to act as a snubber or a stop. The configuration of the frame 20 (whether curved as shown in the Figures or straight) and the location on the frame at which the present invention is mounted will define a distance D between the lower edge 55 of the isolator 50 and the frame 20 when the vehicle is at rest. In general, the distance D should be large enough to accommodate the normal vertical displacement of the engine (in the direction V as shown in FIG. 9) when the vehicle is being driven. However, it is desirable that D be small enough so that in the case of an abrupt, out of the ordinary event (such as hitting a pot hole) the edge 55 will contact the frame, thereby stopping or snubbing the over-flexion of the isolator. Obviously, the distance D can be established by one skilled in the art by varying the configuration and/or composition of the isolator, and/or through the use of a block, or a band, or both taking into consideration the physical characteristics of the vehicle (such as the engine/transmission size and weight, type of vehicle, vehicle suspension, etc.).

It is to be understood that although the invention has been described with particular reference to specific embodiments, the forms of the invention shown and described are to be taken as a non-limiting embodiment and various changes and modifications may be made to the invention without departing from its spirit and scope.

1. A vibration isolation support assembly comprising:
first component bracket fixed to first vehicle component, said first component bracket including a first boss;
a second component bracket fixed to a second vehicle component, said second component bracket including a second boss; and
an isolator mounted over said first boss of said first component bracket and mounted over said second boss of said second component bracket and operable to absorb vibration associated with relative movement between said first vehicle component and said second vehicle component.

2. The vibration isolation support assembly of claim 1, wherein said isolator comprises elastomeric material.

3. The vibration isolation support assembly of claim 1, wherein said isolator comprises elastomeric material surrounding a metal block.

4. The vibration isolation support assembly of claim 1, wherein said isolator comprises a metal band surrounding elastomeric material.

5. The vibration isolation support assembly of claim 1, wherein said first vehicle component is an engine.

6. The vibration isolation support assembly of claim 1, wherein said first vehicle component is a transmission.

7. The vibration isolation support assembly of claim 1, wherein said second vehicle component is a vehicle frame.
